(19) United States
(12) Patent Application Publication
(10) Pub. No.: US 2005/0228724 A1
(43) Pub. Date: Oct. 13, 2005

(54) Prepurchasing installation services for electronic products

(75) Inventor: Anthony Frangiosa, Haverhill, MA (US)

Correspondence Address: LAHIVE & COCKFIELD, LLP., 28 STATE STREET, BOSTON, MA, 02109, US

(73) Assignee: MobileToys, Inc., Haverhill, MA (US)

(21) Appl. No.: 11/032,304

(22) Filed: Jan. 7, 2005

Related U.S. Application Data
(60) Provisional application No. 60/481,872, filed on Jan. 8, 2004.

(51) Int. Cl. G06F 17/60

(52) U.S. Cl. 705/26

(57) ABSTRACT

The present invention is directed towards an InstallCard™ for representing the prepurchase of installation services for consumer electronic products, and the monetary value associated therewith. The present invention provides systems and methods for consumers to purchase InstallCards™ and to obtain installation services for electronic products. Additionally, the present invention provides systems and methods for retailers to sell InstallCards™ to have the purchaser obtain installation services related to electronic products. The use and management of the InstallCard™ is facilitated via a web-site.

### RELATED APPLICATIONS

This present application claims priority to U.S. Provisional Patent Application No. 60/481,872, titled “PROCESS FOR PREPURCHASING INSTALLATION OF MOBILE ELECTRONICS PRODUCTS”, and filed on Jan. 8, 2004 which is incorporated herein by reference.

### TECHNICAL FIELD

The present invention generally relates to the prepurchasing of installation services of electronic devices.

### BACKGROUND INFORMATION

When a consumer purchases a consumer electronics product (such as, but not limited to, mobile electronics products like a radio tuner, satellite radio receiver, compact disc changer, amplifier, equalizer, speakers, mobile video system, Global Positioning System, or security system) arrangements must be made for installation of the product. Several retailers offer on-site installation services. In these cases, the buyer's vehicle is moved to an installation area associated with the retailer after the mobile electronics product is purchased. The product is then installed in to the purchaser's vehicle by personnel affiliated with the retailer. This one-stop shopping process can be convenient for the consumer as the product is purchased and professionally installed in a matter of hours. The installation typically proceeds relatively smoothly as the retailer's installation personnel are familiar with the purchased product and its installation procedure in various vehicles.

However, many retailers offering consumer electronics products do not provide installation services because of the expense associated with hiring trained installers and if mobile electronics, building installation bays. For instance, many discount department stores and auto part stores sell consumer electronics products without offering installation services. Even certain department stores that offer car repair services do not offer installation services for consumer electronics products. There are at least two drawbacks associated with this business model. First, without being able to offer installation services these retailers are prevented from being able to carry certain brands and/or consumer electronics categories that require professional installation and are typically only sold installed, such as vehicle security systems. Second, the retailer faces an increase in returns of purchased products resulting from user frustration with the installation process and competition from third-party installation specialists.

A purchaser attempting to self-install a consumer electronics product often encounters difficulties resulting from a lack of installation knowledge, specialized tools, and testing equipment. Moreover in vehicles, the installation may be made more difficult when there is not an easy fit for the after-market electronics product into the space vacated by the original product. For example, in homes, certain products, such as speakers and subwoofers must be properly located in order to establish proper sound quality and separation. Furthermore, extra cabling, specialized connectors and blank panels may be required to connect the product into the circuits created for the original equipment product and to create an aesthetically pleasing installation in the vehicle dashboard or home. These difficulties can lead to consumer frustration or damage to the product during installation and, ultimately, to the consumer returning the product to the retailer. Given the difficulties faced by consumer when installing consumer electronics devices, it is not surprising that mobile electronics products for example, have a high rate of returns (10%-20%) when not sold with installation, compared to a rate of less than 2% return when sold installed.

In order to avoid the difficulties faced by self-installation, the purchaser may take the product to a third-party installer, since the latter typically has the necessary know-how, tools, equipment, connectors and mechanical pieces, required to retrofit the new product. However, this course of action can also lead to the consumer returning the product to the retailer. The installer, who is typically also a supplier of similar types and brands of consumer electronics products, may offer the buyer their own product bundled with discounted or free installation services.

In order to avoid these situations, some retailers have tried offering installation services through an affiliated third-party installer. In these cases, the retailer enters into an agreement with one or more third-party installers. When a consumer electronics product is purchased, the buyer is given the opportunity to also purchase installation services, where the specific installation service is based on the purchased product. For example, if a buyer purchases speakers, then a relatively inexpensive speaker installation service is simultaneously purchased. If the buyer purchases a receiver, CD player and CD changer, then a considerably more expensive installation service must be purchased. The buyer receives proof of the installation service purchase (e.g., in the form of a purchase receipt) and a list of authorized installers with whom the retailer has an installation service arrangement. The buyer selects an installer from the list and delivers both the purchased consumer electronics product and the accompanying receipt to the installer. Prior to performing the installation, the installer typically validates the receipt, for example, by simply calling the retailer and providing the receipt number. The retailer consults a database listing the receipt numbers to determine the validity of the receipt. If the receipt is valid, the installer performs the installation. Upon completion, the installer indicates on the receipt that the installation has been performed and submits the receipt (or a similar receipt based on the original) to the product retailer for reimbursement of the service charges. The arrangement between the retailer and the installer governs the reimbursement amount, which likely will be different than the installation service price typically paid by the consumer. The retailer pays the installer the agreed upon price and the transaction has been completed. In a slight variation of this process, instead of the retailer having a direct relationship with the independent installers, the retailer contracts with a third party provider to administer the installation process transactions. In this case, the installer submits proof that the installation was completed to the third party provider, who then pays the installer an agreed-upon installation price and collects an agreed-upon installation cost from the product retailer.

While these efforts may solve some of the problems associated with consumer electronics installation services, they still have undesirable characteristics. For example, the processes described above must be initiated by a trained salesperson, usually as part of the sales process associated with the consumer electronics device. Further, the consumer is limited to having the installation done by an installer that has an agreement with the retailer. An installer that is acceptable to the consumer may not exist. Furthermore, the overhead associated with the processes described above can be prohibitive, especially for retailers having several locations. An installer may have to call many different locations before being able to verify the installation receipt is valid. Moreover, the retailer must keep its list of valid, outstanding receipts up-to-date.

As such, systems and methods for selling installation services of electronic devices which do not constrain selection of the installation service and which has minimal overhead is desired. Furthermore, systems and methods are desired for the prepurchasing of installation services of electronic devices, and for the prepurchaser to more conveniently identify an installer and schedule an installation date.

### SUMMARY OF THE INVENTION

The present invention provides easy to merchandise, and easy to use methods for identifying and having a professional installation of electronics devices, such as consumer electronic devices. The InstallCard™ of the present invention provides for the prepurchasing of installation services for electronic devices. The installation services may be prepurchased with or separate from the purchase of the electronic device. Systems and methods of using the InstallCard™ provide consumers with desired installation services including installer recommendation, scheduling of installation, and warranty services. Furthermore, retailers can offer installation services to their customers via the InstallCard™ without the overhead of having installation service personnel, infrastructure, and facilities. By offering professional installation services via the InstallCard™, retailers can enhance their electronic product sales and reduce product returns related to installation issues. By prepurchasing installation services via the InstallCard™, consumers can purchase installation services from retailers not providing such services directly. Additionally, consumers can have choices of when and where to prepurchase the installation services. For example, consumers can prepurchase installation services separately from the purchase of the electronic product, or from a retailer different than the retailer of the electronic product. Via a web-site associated with InstallCard™, consumers can identify the desired installer and schedule the desired installation date. As such, the present invention will increase the consumer's satisfaction in connection with the purchase of the electronic product. The prepurchased installation services of the present invention will reduce the consumer returning the product related to installation issues and will provide consumers with convenient installation recommendations, installer choices and scheduling of installation services.

In one aspect, the present invention relates to a token having a store of value representing an agreed upon form of payment for a service to be provided by a service provider. The token is a physical item, such as a card, representing a service to be provided by one plurality of service providers. The token has a marking identifying the service and a store of value acceptable as a form of payment by a service provider for the service identified by the marking. Upon purchase of the token, the store of value of the token has a value acceptable by at least one service. In one embodiment, the token includes a card and a card holder.

In another embodiment of the present invention, a service provider accepts the token in exchange for invoking performance of the service. In one embodiment, the token has an identifier to provide access to available service providers via a web site. The token may include a unique identifier assigned to the token and the identifier may include a numeric, an alphanumeric and/or a barcode.

In a further embodiment, the marking on the token may include a color, a text and/r a graphical representation identifying a service and/r an electronic device associated with the service. The service may include installation, maintenance or a warranty service of an electronic device. The marking on the token may identify one or more of the following electronic devices: 1) stereo, 2) radio, 3) CD changer, 4) speakers, 5) amplifier, 6) equalizer, 7) mobile video, 8) radar detector, 9) global positioning system, 10) navigation system, 11) security system, 12) hands-free system and 12) a remote starter.

In another aspect, the present invention relates to a method for using a token representing a pre-paid service to obtain services. The method includes the step of providing for purchase a token representing a service to be performed by a service provider. The token has a store of value representing an agreed form of payment by the service provider. The method further includes purchasing the token for monetary value and upon purchasing the token, the store of value of the token has a value acceptable as payment by the service provider.

In one embodiment, the method includes activating the token to provide a valid token for purchasing the service. The method includes presenting the token to the service provider and the service provider recognizing the token as payment for the service. The method includes selecting a service provider and scheduling a service appointment with the service provider via a web site accessible by using an identifier of the token.

In another embodiment, the method includes validating, by the service provider, the token for payment for the service. The token includes a card with a marking identifying the service and/or a unique identifier assigned to the token. The service provided by the service provider and represented by the token may include the installation, maintenance and a warranty service of an electronic device. Furthermore, the service to be performed via the token may be associated with one or more of the following electronic devices: 1) stereo, 2) radio, 3) CD changer, 4) speakers, 5) amplifier, 6) equalizer, 7) mobile video, 8) radar detector, 9) global positioning system, 10) navigation system, 11) security system, 12) hands-free system and 12) a remote starter.

The details of various embodiments of the invention are set forth in the accompanying drawings and the description below.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1A is a block diagram depicting an illustrative embodiment of the InstallCard™;

FIG. 1B is a flow diagram depicting steps performed in practicing an illustrative method of the present invention;

FIG. 2A is a block diagram of a computing device for practicing an illustrative embodiment of the present invention;

FIG. 2B is a block diagram of the InstallCard™ web site for practicing another illustrative embodiment of the present invention; and

FIGS. 3A-3E are block diagrams depicting illustrative user interfaces of the InstallCard™ web site.

### DETAILED DESCRIPTION

Certain embodiments of the present invention are described below. It is, however, expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not expressly made herein, without departing from the spirit and scope of the invention.

The illustrative embodiment of the present invention is directed towards an InstallCard™, which is a physical token of a card representing the prepurchase of installation services for consumer electronic products, and the stored or monetary value associated therewith. The illustrative embodiment provides systems and methods for consumers to purchase InstallCards™ and to obtain installation services for electronic products. Additionally, the illustrative embodiment provides systems and methods for retailers to sell InstallCards™ to have the purchaser obtain installation services related to electronic products. Furthermore, use of the InstallCard™ is facilitated via a web-site to activate and maintain the state of InstallCards™. Via the web-site consumers can identify installers and schedule installations, and service providers can validate InstallCards™ and provide notification of completion of installation services for payment.

Although the illustrative embodiment of the present invention will be discussed in connection with the installation of consumer electronic products, such as mobile consumer products, the present invention can be applied to installation services related to any type of item, such as commercial equipment and household appliances. Furthermore, the present invention can be applied to any other type of service, such for example, maintenance or warranty services, and services not related to installation.

In one aspect, the present invention is directed towards an InstallCard™, which is a physical token representing the purchase of a service, such as an installation service, related to a consumer electronic product, such a mobile electronic device, e.g. automobile stereo systems or components thereof. The InstallCard™ is purchased prior to the performance of the service, and as such represents a prepurchased service. Since the InstallCard™ is purchased, it represents a monetary value of the service and agreed upon form of payment for the service between the purchaser of the InstallCard™ and the service provider that accepts the InstallCard™ as a form of payment for performing such services. In some embodiments, the purchase price of the InstallCard™ may be less than or greater than the value the service provider may accept for providing the service represented by the InstallCard™. In one embodiment, the retailer, wholesale or distributor selling the InstallCard™ may discount the price of the InstallCard™ and subsidize the difference between what the consumer buy the service for and what the service provider is paid.

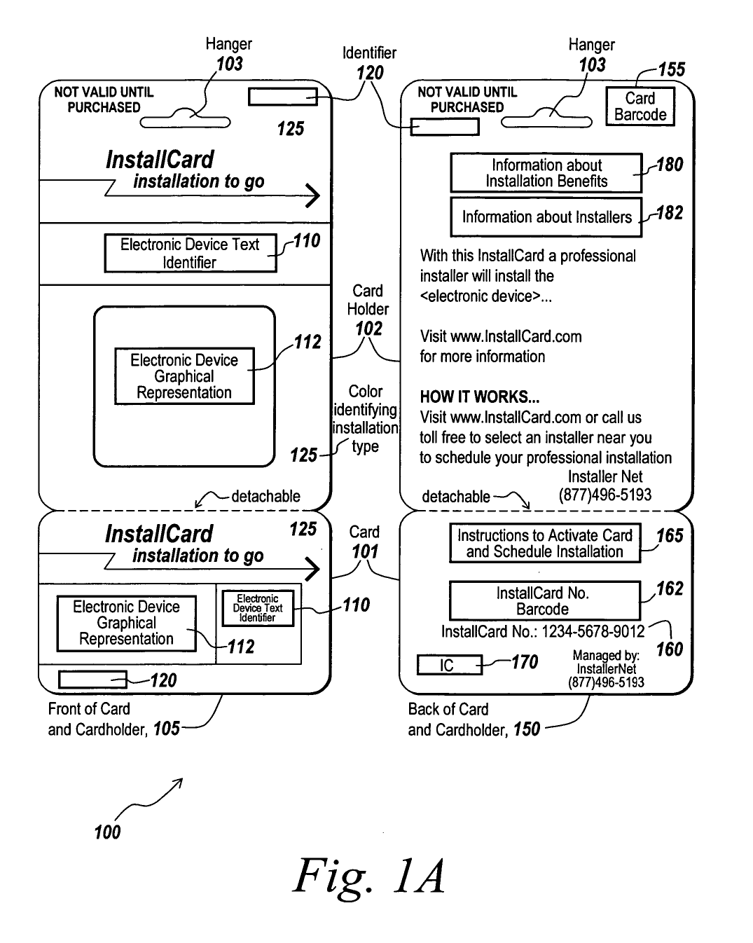

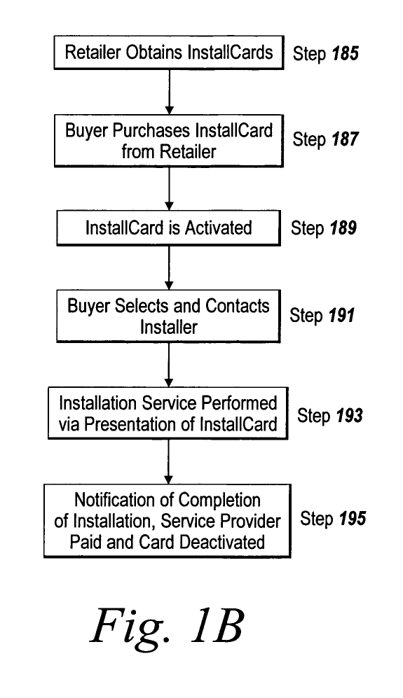

FIG. 1A depicts an illustrative embodiment of the InstallCard™. In brief overview, the InstallCard™ 100 comprises a card 101 and a card holder 102. The card portion 101 may be detachable from the card holder 102 portion. Each of the card 101 and card holder 102 may form a front 105 of the InstallCard™ 100, and a back 150 of the InstallCard™ 100. Additionally, the InstallCard™ 100 may comprise a hanger 103 for hanging the InstallCard™ on any hook suitable for holding such a card, such as retail display case. The front 105 and/or back 150 portions of the InstallCard™ may comprise a card type identifier 120, such as numeric or alpha-numeric code to indicate the type of InstallCard™. This may be used as a product code as is known in the art with respect to retailing and the use of product identifiers.

The front of the card 105 comprises elements to indicate the type of installation service to be performed. The front 105 portion of the card 101 and card holder 102 may each have an electronic device text identifier 110 and an electronic device graphical representation 112. The electronic device text identifier 110 may provide any form of characters, such a word, term, phrase, alphanumeric characters or any combination thereof, descriptive of or otherwise identifying a specific electronic device. For example, the electronic device text identifier 110 may comprise the words “car stereo” to indicate that the InstallCard™ 100 is for a car stereo installation. Other examples of the electronic device text identifier 110 are “satellite radio”, “speakers/subwoofers”, “remote starter”, “amplifier/equalizer”, “CD changer”, “security system”, “radar detector”, “mobile video”, “GPS/navigation”, and “hands-free system.” Likewise, the electronic device graphical representation 112 may provide any form of graphical representation, such as a symbol, image, picture, drawing, sketch, illustration, model or any combination thereof, graphically describing or otherwise graphically identifying a specific electronic device. For example, the electronic device graphical representation 112 may comprise an illustrative picture of a typical car stereo to indicate that the InstallCard™ 100 is for a car stereo installation. In an exemplary embodiment, the electronic device graphical representation 112 corresponds to and graphically represents the electronic device identified by the electronic device text identifier 110. For example, the electronic device graphical representation 112 may provide a graphical representation for any of the following as identified by the electronic device text identifier 110: are satellite radio, speakers/subwoofers, remote starter, amplifier/equalizer, CD changer, security system, radar detector, mobile video, GPS/navigation, and hands-free system. One ordinarily skilled in the art will appreciate and recognize that the text identifier and graphical representation can identify and represent any type of service and/or any type of device, equipment, appliance, etc. for which the service is associated with.

As depicted in the illustrative embodiment of the InstallCard™ 100 in FIG. 1A, the electronic device text identifier 110 and electronic device graphical representation 112 are on both the card 101 and card holder 102. Since the card 101 can be detached from the card holder 102, both the card 101 and the card holder 102 can provide graphical and text indicators of the type of installation service for a specific electronic device. In other embodiments (not shown), either just the card 101 or the card holder 102 may have the electronic device text identifier 110 and graphical representation 112, and may have either only the electronic device text identifier 110 or the electronic device graphical representation 112.

Furthermore, the color 125 of the front 105 portion of the InstallCard™ 100 may indicate the service to be performed and/or the electronic device for which to perform the service. The color 125 may comprise a solid color, various shades of a color family, color patterns, color themes, or any combination thereof. For example, a red or reddish front 105 portion of the InstallCard™ 100 may indicate the InstallCard™ 100 is for car stereo related services, or more specifically, for a car stereo installation service. In other embodiments, any shade of red may indicate that the service to be performed, such as installation, upgrade, maintenance or warranty services, is associated with car stereos. In another embodiment, any shade of red may indicate that the service to be performed with car stereos and different shades of red, or in combination with another color, may indicate the type of service. Additionally, the color 125 may form the background of the entire portion of the front 105 or may only form a smaller portion of the front 105 of the InstallCard™ 100, such as one or more color stripes or a color border. The color 125 representation may also be included on the back portion 150 of the InstallCard™ 100, or just on any portion of the front and/or back of the card 101, or on any portion of the front and/or back the card holder 102. One ordinarily skilled in the art will recognize and appreciate that the color may be used to identify any combination of type of electronic device and/or type of service to be performed, and furthermore, any type of color scheme on any portion of the InstallCard™ 100 may be used to identify the electronic device and/or service.

Although generally this aspect of an embodiment of the present invention is described and referred as the InstallCard™ 100, one ordinarily skilled in the art will appreciate that any type of physical token referred to by any name may be used and that any type of elements, graphical, textual or otherwise, may be arranged on the token to represent the service and/or the electronic device associated with the service in accordance with the present invention as described herein. As such, the InstallCard™ 100 can be made of or consist of any type of material, such as plastic, paper or metal and be any type of size and shape. In an exemplary embodiment, InstallCard™ 100 is made up of a plastic that is durable and can have imprinted on it any type of text, color, graphics, bar codes, etc. The card 101 portion may be of approximate size and shape as to any other types of plastic cards, such as credit cards and gift cards. The card holder 102 portion may be of any suitable size and shape for holding the card 102 and for providing a means and/or mechanism for displaying the card 101 such as a via a hook and hanger 103, or for a person to conveniently see and grasp the InstallCard™ 100. In some embodiments, the card 101 portion of the InstallCard™ 100 is sold, purchased or otherwise provided without the card holder 102.

Still referring to FIG. 1A, the back 150 of the InstallCard™ 100 may comprise information about installation benefits 180, information about installers 180 and any other informed related to using the card, how the card works or what electronic device the card provided services for. This information is shown on the back of the card holder 102 in FIG. 1A, but any portion of the information may also be on the card 101, may be just on the card 101, or both on the card 101 and the card holder 102. The back of the card holder 101 may also comprise a card barcode 155. The card barcode 155 may provide a barcode representation of the product identifier such as the card type identifier 120, or may otherwise used to identify to any type of barcode reader, the type of the InstallCard™ 100, the product type of the card holder 102 or the card 101, or any other desired information.

On the back of the card 101 portion of the InstallCard™ 100, the card 101 may comprise an InstallCard™ Number 160, an InstallCard™ Number Barcode 162, and instructions to activate the card and schedule installation 165. The InstallCard™ Number 160 may comprise any form of numeric, alphanumeric, any combination thereof, or any other type of identifier to uniquely identify the InstallCard™ 100. The InstallCard™ Number Barcode 162 comprises a barcode representation of the InstallCard™ Number 160 to identify the card to any type of barcode reader. The InstallCard™ Number Barcode 162 may comprise any other information embedded in the barcode representation as one ordinarily skilled in the art will appreciate. The instructions 165 may comprise textual information indicating to a reader of the information how to activate the card and schedule a service associated with card 100, such as installation. In an exemplary embodiment, the instructions 165 provide step by step instructions for activating the card 100 and provide a reference to an InstallCard™ web site that will be discussed in more detail below. In some embodiments, the instructions 165 include an indication that proof of purchase of the InstallCard™ 100 will be required at time of installation, or in other cases, at time of activation.

The service process, such as an installation service, according to the present invention of the InstallCard™ 100 is more efficient and less costly for all parties and further reduces the probability of a merchandise return to the product retailer. FIG. 1B depicts an illustrative method of the present invention for using the InstallCard™ 100 to obtain services. According to this process, in conjunction with or separate from purchasing a consumer electronics product requiring installation, the buyer has the option of purchasing an InstallCard™ 100 from the retailer. At step 185 in the illustrative method, the retailer obtains one or more InstallCards™ 100 from a distributor of or provider of InstallCards™ 100, such as those distributed by Mobile Toys, Inc. of Haverhill, Mass. Typically, the InstallCard™ 100 is displayed proximate to the consumer electronics products on or near the retailer's display shelves. Since the cards are tangible merchandise with a tangible value, they are amenable to placement on the retailer's shelves or for listing in a catalog or on a website. That is, no sales clerk is necessary to initiate the installation service purchase opportunity. Since most buyers will consider the InstallCard™ 100 process to be a time-saving and convenient method for accomplishing installation of a consumer electronics product, the cards will likely enhance the selling features of the consumer electronics product itself. They also eliminate an important impediment in the form of arranging for the installation, and accomplish this objective simultaneously with the purchase of the electronics product, that otherwise could not be offered without hiring trained installers, and the necessary infrastructure to facilitate the installation either building installation bays on-site, or vehicles and equipment for remote installation service.

The InstallCards™ 100 may be made available in a number of denominations, with each denomination representing an identified installation procedure value and having a unique SKU bar code. The retailer can program its point-of-sale terminals to establish a price for each of the many different SKU codes. Thus, upon purchasing a consumer electronics product, the buyer can also purchase an InstallCard™ 100 that covers the installation cost. This would also be advantageous when the consumer electronics product is purchased as a gift. The gift bearer would typically not want the recipient to bear the cost of installation, and thus using the InstallCard™ process, the giver can present a complete, no-cost gift to the recipient. In one embodiment, the InstallCard™ 100 embodies a fixed fee, designated to cover the purchaser's price for a product installation. For example, an InstallCard™ 100 to cover the installation of two speakers may have an installation value of $40, representing a typical price for speaker installation. The price of the card could be discounted by the retailer at its discretion, i.e. below the “install value,” in an effort to attract buyers and encourage the purchase of a consumer electronics product. In some of these embodiments, the value of the cards may be indicated only by a color present on the InstallCard™ 100, such as a stripe or coloring on some other portion of the card.

At step 187 of the illustrative method of FIG. 1B, the InstallCard™ 100 is purchased from the retailer. After the card has been purchased and before the installation can be performed, the card must be activated by the buyer at illustrative step 189 of the present invention. This may be accomplished by the buyer calling a toll free telephone number shown on the card or by visiting the InstallCard™ provider's website, such as the website provided at www.installcard.com. Each card has a unique number that must be provided to InstallCard™ personnel, who will then activate it. In other embodiments, the InstallCard™ 100 is sold already validated and the installer has the responsibility for invalidating the card when installation services are complete. In other embodiments, the InstallCard™ 100 is activated upon purchase.

At the time of purchase, the buyer also receives a list of member installers who are authorized to accept the InstallCard™ 100 in return for the product installation. The list can also be provided by the InstallCard™ website, or by any other suitable means. At step 191 of the illustrative method of FIG. 1B, the buyer selects and contacts the installer. In one embodiment, the buyer of the InstallCard™ 100 selects and contacts the installer via the website for the InstallCard™ as will be described in more detail below.

At step 193 of the illustrative method, the service associated with the InstallCard™ 100 is presented to the service provider and the service is performed. In one embodiment, the buyer takes his electronic product and the InstallCard™ to the selected installer or service provider. The buyer presents to the installer or service provider the InstallCard™ 100 as form of payment for the service, and optionally any type of proof of purchase of the InstallCard™ 100, proof of activation or that the InstallCard™ 100 is otherwise valid or has not been used before. In other embodiments, the service provider may come to a desired location, such as a house, boat or plane or any other fixed or mobile structure, to perform the service. The InstallCard™ 100 may be presented and/or exchanged as an agreed form of payment prior to, during or after the performance of the service as may be allowed by the service provider or agreed between the buyer and the service provider. In some embodiments, the InstallCard™ 100 may cover only a portion of the services performed by the service provider and the buyer may purchase these additional services by any means as known in the art.

At step 195 of the illustrative method of the present invention, when the installation is completed the installer notifies the InstallCard™ provider. This can be done via the InstallCard™ supplier's website, through a toll-free telephone number or by any other suitable means. Upon receipt of notification, the card supplier pays the installer and deactivates the card. In some embodiments, the InstallCard™ 100 may be reactivated or otherwise reused by the same buyer or different buyer and also with a different service provider. The revenue source for the InstallCard™ supplier is selling of the individual InstallCard™ 100 to retailers. Although generally discussed herein as retailers obtaining and selling InstallCards™ 100, any type of entity, organization, groups or individuals, such as a wholesales, distributors, or any other non-retailer, may obtain and sell InstallCards™ 100. The use of the InstallCard™ process simplifies and automates the service process, such as the installation of consumer electronics.

In still other embodiments, the InstallCard™ may be provided as a “smart card,” which has an integrated circuit 170 or IC embedded in it as depicted on the back 150 of the card 101 in FIG. 1A. The integrated circuit 170 may be programmed with the amount for which the card is valid. In some embodiments, the integrated circuit 170 provides countdown timer functionality that causes the card to expire if not used within a predetermined period of time. The integrated circuit 170 on the “smart card” may also store a personal identification number (PIN) that must be supplied at the time of installation before the card will indicate that it is valid. In other embodiments, the “smart card” may require the provision of a time-based passcode, digital certificate, private cryptographic key, or biometric data to indicate that it is valid. For example, in one embodiment the serial number of the consumer electronics product is “hashed” to create a code that is stored in the smart card. When the consumer presents the consumer electronics element for which installation is desired, the installer performs the same hash on the serial number of that product. If the result obtained by the installer matches the result stored in the smart card, the smart card indicates that installation may proceed. In other embodiments, the InstallCard™ 100 via the integrated circuit 170 or the InstallCard™ Number Barcode 162 may be “swiped” or otherwise read by any suitable reading device or software to activate/deactivate, verify, validate, credit/debit value or otherwise perform any other operation or function associated with InstallCard™ 100. In further embodiments, the integrated circuit 170 or the InstallCard™ Number Barcode 162 may be read or otherwise used to interface with or provide information to the InstallCard™ web site.

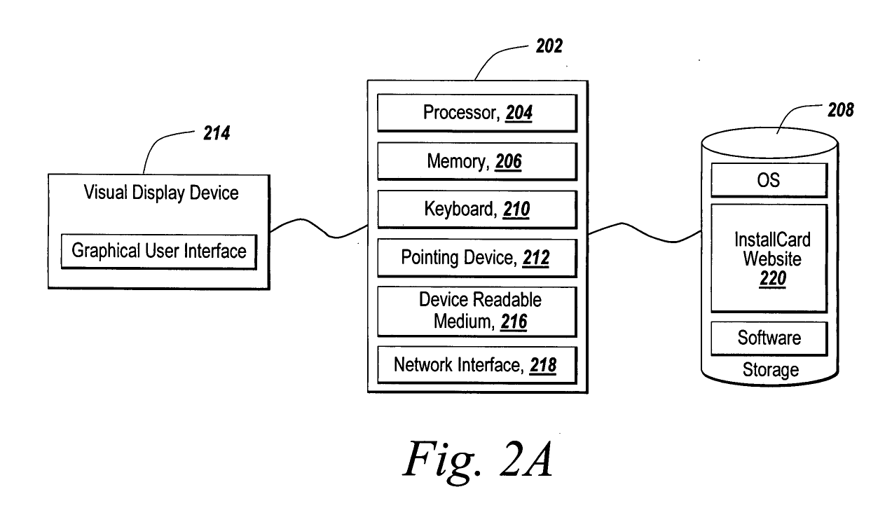

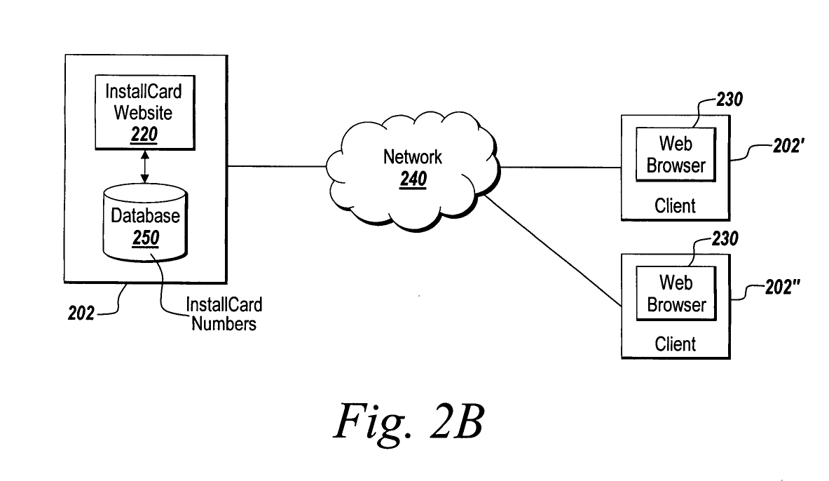

In another aspect, the present invention is directed towards the use of a website with the InstallCard™ 100. FIG. 2A depicts an environment suitable for practicing an illustrative embodiment of the website of the present invention. The environment includes a computing device 202 having memory 206, on which software according to one embodiment of the present invention may be stored, a processor (CPU) 204 for executing software stored in the memory 206, and other programs for controlling system hardware. The memory 206 may comprise a computer system memory or random access memory such as DRAM, SRAM, EDO RAM, etc. The memory 206 may comprise other types of memory as well, or combinations thereof. A human user may interact with the computing device 202 through a visual display device 214 such as a computer monitor, which may be used to display a graphical user interface (GUI). The computing device 202 may include other I/O devices such a keyboard 210 and a pointing device 212, for example a mouse, for receiving input from a user. Optionally, the keyboard 210 and the pointing device 212 may be connected to the visual display device 214. The computing device 202 may include other suitable conventional I/O peripherals. For installing software programs, the computing device 202 may support any suitable device readable medium 216, such as a CD-ROM, DVD-ROM floppy disks, tape device, USB device, hard-drive or any other suitable device. The computing device 202 may further comprise a storage device 208, such as a hard-drive or CD-ROM, for storing an operating system and other related software. The present invention of the InstallCard™ website 220 may comprise software that is installed via a device readable medium 216 and stored in the storage device 208. Additionally, the operating system and the InstallCard™ website 220 can be run from a bootable CD, such as, for example, KNOPPIX®, a bootable CD for GNU/Linux. The InstallCard™ website 220 can comprise an application, module, service, library, database, software component or any other type of computer program or executables, and any combinations thereof, which is designed to and capable of executing the functionality supporting the use of the InstallCard™ 100 as described herein.

Additionally, the computing device 102 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), cluster interconnection (Myrinet), peripheral component interconnections (PCI, PCI-X), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device to any type of network capable of communication and performing the operations described herein. Moreover, the computing device 102 may be any computer system such as a workstation, desktop computer, server, laptop, handheld computer or other form of computing or telecommunications device that is capable of communication and that has sufficient processor power and memory capacity to perform the operations described herein.

FIG. 2B depicts another environment suitable for practicing an illustrative embodiment of the present invention, where the InstallCard™ website 220 is deployed in a networked computer system. In a broad overview, the networked system depicts a multiple node network 240 for running the InstallCard™ website 220 on a computing device 2002 and have one or more clients connecting to and communicating with the InstallCard™ website 220 via computing devices 202′ and 202″. The network 240 can be a local area network (LAN), such as a company Intranet, a metropolitan area network (MAN), or a wide area network (WAN) such as the Internet. In one embodiment (not shown), the network 240 comprises separate networks, which may be of the same type or may be of different types. The topology of the network 240 over which the clients 202′, 202″ communicate may be a bus, star, or ring network topology. The network 240 and network topology may be of any such network 240 or network topology capable of supporting the operations of the present invention described herein.

The clients 202′-202″ can connect to the network 240 through a variety of connections including standard telephone lines, LAN or WAN links (e.g., T1, T3, 56 kb, X.25, SNA, DECNET), broadband connections (ISDN, Frame Relay, ATM, Gigabit Ethernet, Ethernet-over-SONET), cluster interconnections (Myrinet), peripheral component interconnections (PCI, PCI-X), and wireless connections, or some combination of any or all of the above. Connections can be established using a variety of communication protocols (e.g.,.TCP/IP, IPX, SPX, NetBIOS, Ethernet, ARCNET, Fiber Distributed Data Interface (FDDI), RS232, IEEE 802.11, IEEE 802.11a, IEEE 802.11b, IEEE 802.11g, and direct asynchronous connections). The network connection and communication protocol may be of any such network connection or communication protocol capable of supporting the operations of the present invention described herein.

In the network 240, each of the clients 202′-202″ are configured to and capable of running at least a portion of the present invention. As a web based application, the clients 202′-202″ may have a web browser 230 or any other suitable software for communicating and interacting with the InstallCard™ website 220. Each of the clients 202′-202″ can be any type of computing device as described above and respectively configured to be capable of computing and communicating the operations described herein. For example, any of the clients 202′-202″ may be a mobile computing device such as a notebook or PDA. One ordinarily skilled in the art will recognize the wide range of possible combinations of types of computing devices capable of communicating over a network.

The network 240 and network connections may include any transmission medium between any of the clients 202′-202″, such as electrical wiring or cabling, fiber optics, electromagnetic radiation or via any other form of transmission medium capable of supporting the operations of the present invention described herein. The methods and systems of the present invention may also be embodied in the form of computer data signals, program code, or any other type of transmission that is transmitted over the transmission medium, or via any other form of transmission, which may be received, loaded into, and executed, or otherwise processed and used by a computing device 102 to practice the present invention.

The InstallCard™ website 220 and web browser 230 can be capable of and configured to operate on the operating system that may be running on any of the computing devices 202-202″. Each computing devices 202-202″ can be running the same or different operating systems. For example, computing device 202 can be running Microsoft® Windows, and computing device 202′ can be running a version of UNIX, and computing device 202″, a version of Linux. Or each computing device 202-202″ can be running the same operating system, such as Microsoft® Windows. Additionally, the InstallCard™ website 220 and web browser 230 can be capable of and configured to operate on and take advantage of different processors of any of the computing device. For example, the InstallCard™ website 220 can run on a 32 bit processor of one computing device 202 and a 64 bit processor of another computing device 202′. Furthermore, the InstallCard™ website 220 and/or web browser 230 can operate on computing devices that can be running on different processor architectures in addition to different operating systems. One ordinarily skilled in the art will recognize the various combinations of operating systems and processors that can be running on any of the computing devices. In summary, the InstallCard™ website 220 and web browser 230 may be deployed across a wide range of different computing devices, different operating systems and different processors in various network topologies and configurations. One ordinarily skilled in the art will appreciate the various ways the present invention may be practiced in a web based and networked system.

The InstallCard™ website 220 may include or otherwise communicate with a database 250 or any other type of suitable storage. The database 250 may comprise the InstallCard numbers, such as those numbers identified by the InstallCard™ Number 160 and the InstallCard™ Number Barcode 162 of the InstallCard™ 100 as depicted in FIG. 1A. The InstallCard™ website 220 may include any type of suitable structure and logic for storing, tracking or managing the InstallCard™ numbers. In one embodiment, the InstallCard™ website 220 tracks and manages the state of each InstallCard™ assigned a number from pre-activation through distribution, purchase and use, and then deactivation. In another embodiment, the InstallCard™ website 220 provides for the activation and verification of valid InstallCard™ numbers.

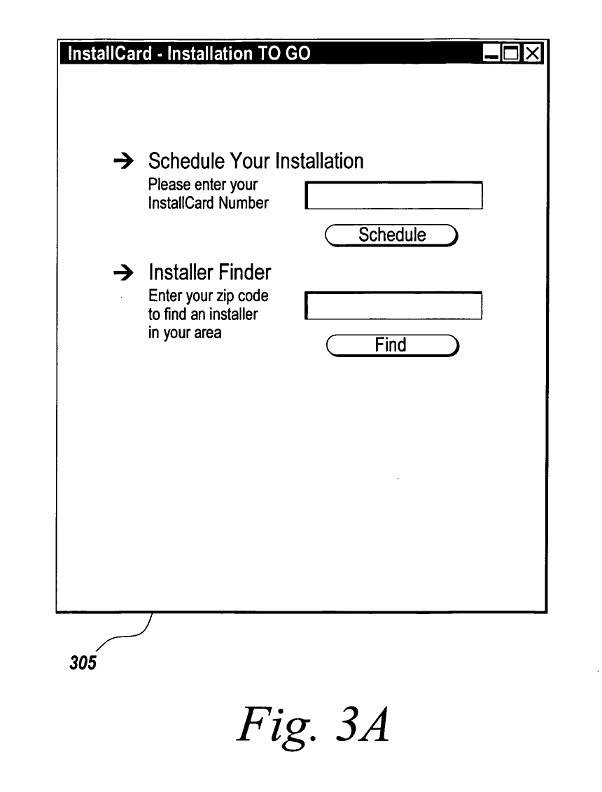

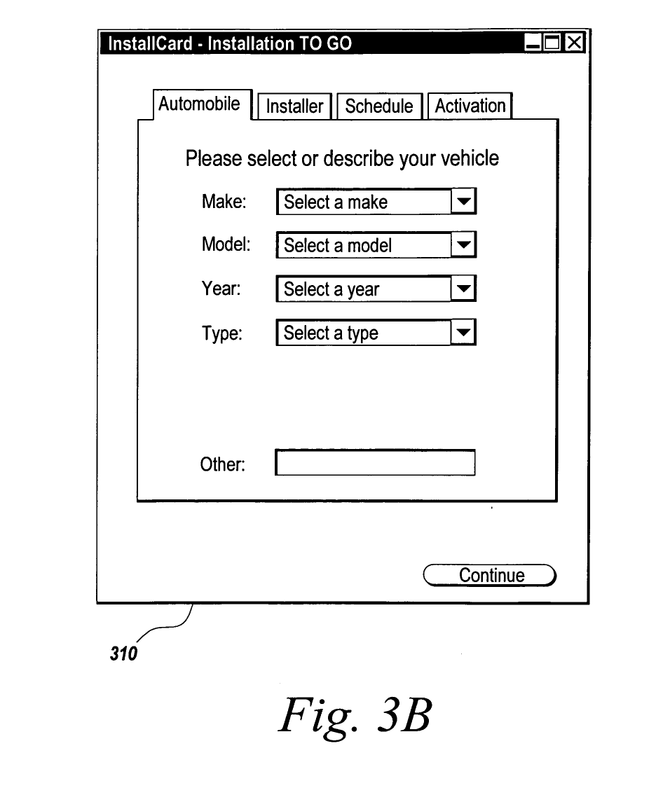

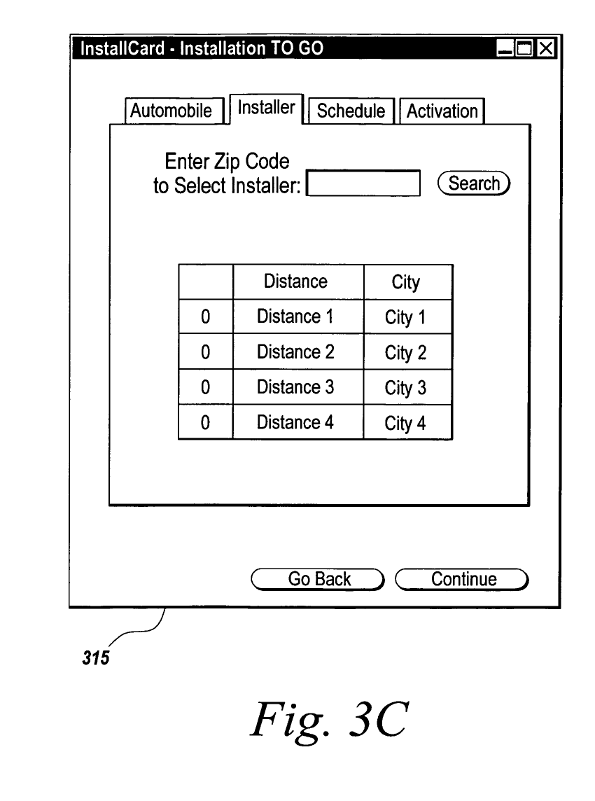

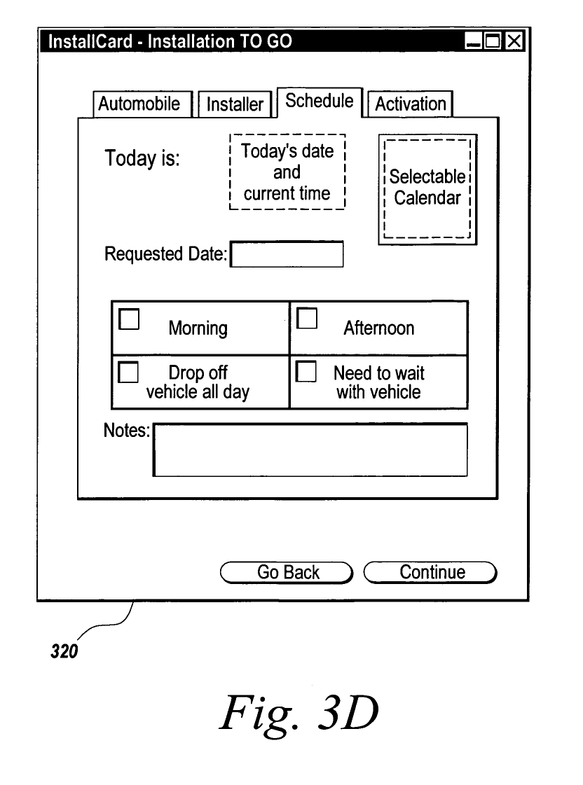

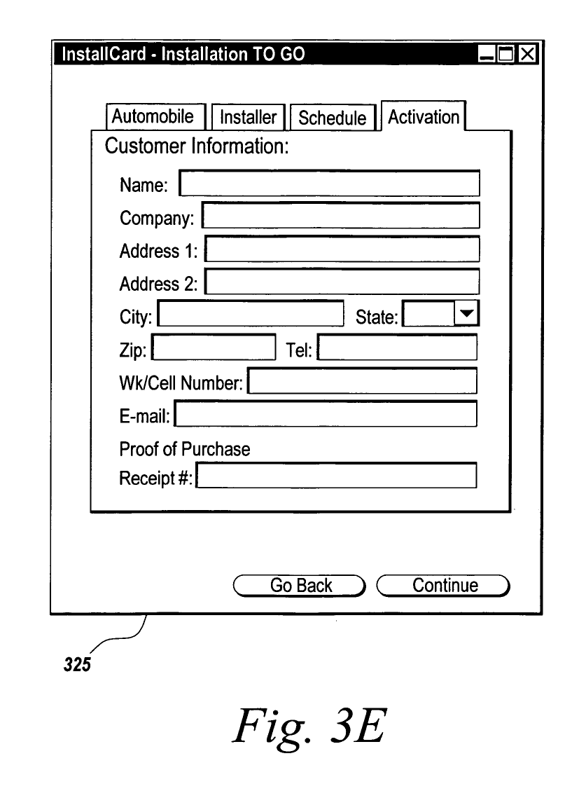

The use of the InstallCard™ 100 with the InstallCard™ website 220 provides a means for InstallCard™ buyers to conveniently activate cards, receive service related information, select and find services providers, and schedule service appointments. Additionally, it can provide a means for service providers, such as authorized installers, to communicate with the InstallCard™ provider or distributor about the status of the performance and payment of services. FIGS. 3A-3E depict illustrative user interfaces, such as web pages, of the InstallCard™ website 220 for a user to schedule an installation service and find installers. At illustrative graphical user interface 305 of FIG. 3A, the user can initiate the scheduling of an installation by entering a valid InstallCard™ number. The user can also find authorized installers by entering a desired zip code and selecting the find command button. The user will be presented with a list of installers by location and distance similar to the graphical user interface 315 of FIG. 3C.

After entering a valid InstallCard™ number and selecting the schedule button, the user is presented a series of graphical user interfaces 310, 315, 320 and 325 as depicted in FIGS. 3B through 3E. Through these user interfaces, the user selects or describes the automobile for the installation (310 of FIG. 3B), find and selects a desired installer (315 of FIG. 3C) and schedules an installation date (320 of FIG. 3D). The user then activates the card by entering customer information and proof of purchase as illustrated by the example graphical user interface 325 of FIG. 3E. One ordinarily skilled in the art will recognize and appreciate that the graphical user interfaces of the InstallCard™ website 220 may comprise any arrangement of user interface elements and may include any functionality or logic for the management of InstallCards™ in conjunction with their use as described herein. Although generally described as a website, one ordinarily skilled in the art will appreciate that the InstallCard™ website 220 may be implemented as any type of application or software program, such as a desktop application or distributed application.

The teachings of the present invention can also be applied to many different types of services, some of which are not necessarily associated with the purchase of a product. For example, upon purchase of a washer or dryer, the buyer can also purchase a given number of service hours after expiration of the product warranty. The card cost is determined by multiplying a predetermined hourly rate and the number of hours purchased. As the service hours are utilized, they are debited from the service card much like dollars are debited from a debit card. A similar card can also be purchased to cover the out-of-pocket costs not covered by a product warranty. For example, some automobile warranty plans include a deductible amount that the consumer must pay before the warranty coverage begins. Certain warranties do not cover the cost of new parts. The InstallCard™ could be used to cover all or a portion of these excluded costs. Moreover, this process could be used for selling other items other than consumer electronics that require installation, such as garage doors, home appliances, other automotive parts or accessories. This process could also be used for non-installation services, for example auto repair, oil change, or any service that a retailer would like to be able to sell “off the shelf” that is not currently available.

Many alterations and modifications may be made by those having ordinary skill in the art without departing from the spirit and scope of the invention. Therefore, it must be expressly understood that the illustrated embodiments have been shown only for the purposes of example and should not be taken as limiting the invention, which is defined by the following claims. These claims are to be read as including what they set forth literally and also those equivalent elements which are insubstantially different, even though not identical in other respects to what is shown and described in the above illustrations.

1. A token having a store of value representing an agreed upon form of payment for a service to be provided by a service provider, the token comprising:
a physical item representing a service to be provided by at least one of a plurality of service providers, the physical item comprising:
a marking identifying the service; and
a store of value acceptable as a form of payment by at least one of the plurality of service providers for the service identified by the marking.

2. The token of claim 1, wherein upon purchase of the token, the store of value of the token comprises a value acceptable by the least one service provider for performing the service.

3. The token of claim 1, wherein the least one service provider accepts the token in exchange for invoking performance of the service.

4. The token of claim 1, wherein the token comprises an identifier to provide access to the plurality of service providers via a web site.

5. The token of claim 1, wherein the token comprises one of a card and a card holder.

6. The token of claim 1, wherein the token comprises a unique identifier assigned to the token, the identifier comprising one of a numeric, an alphanumeric and a barcode.

7. The token of claim 1, wherein the marking comprises one of a color, a text and a graphical representation identifying one of the service and an electronic device associated with the service.

8. The token of claim 1, wherein the service comprises one of an installation, a maintenance and a warranty service of an electronic device.

9. The token of claim 1, wherein the marking identifies one or more of the following electronic devices: stereo, radio, CD changer, speakers, amplifier, equalizer, mobile video, radar detector, global positioning system, navigation system, security system, hands-free system and a remote starter.

10. A method for using a token representing a pre-paid service to obtain services, the method comprising the steps of:
providing for purchase a token representing a service to be performed by a service provider, the token having a store of value representing an agreed form of payment by the service provider;
purchasing the token for monetary value; and
upon purchasing the token, the store of value of the token comprises a value acceptable as payment by the service provider.

11. The method of claim 10, comprising activating the token, the activated token valid for purchasing the service.

12. The method of claim 10, comprising presenting the token to the service provider and the service provider recognizing the token as payment for the service;

13. The method of claim 10, comprising selecting a service provider via a web site accessible by using an identifier of the token.

14. The method of claim 10, comprising scheduling a service appointment with the service provider via a web site accessible by using an identifier of the token.

15. The method of claim 10, comprising validating, by the service provider, the token for payment for the service.

16. The method of claim 10, wherein the token comprises a card with one of a marking identifying the service and a unique identifier assigned to the token.

17. The method of claim 10, wherein the service comprises one of an installation, a maintenance and a warranty service of an electronic device.

18. The method of claim 10, wherein the service is to be performed in connection with one or more of the following electronic devices: stereo, radio, CD changer, speakers, amplifier, equalizer, mobile video, radar detector, global positioning system, navigation system, security system, hands-free system and a remote starter.
